(19) United States
(12) Patent Application Publication
(10) Pub. No.: US 2017/0351829 A1
(43) Pub. Date: Dec. 7, 2017

(54) SMART DEVICE FOR MONITORING AND CAPTURING PATIENT DATA

(71) Applicant: IXICO Technologies Limited, London (GB)

(72) Inventors: Robin Mitja Benjamin Wolz, London (GB); Derek Lionel Glendon Hill, London (GB)

(21) Appl. No.: 15/527,552

(22) PCT Filed: Nov. 18, 2015
(86) PCT No.: PCT/GB2015/053497

§ 371 Date: May 17, 2017

(30) Foreign Application Priority Data
Nov. 18, 2014 (GB) 1420436.6

(51) Int. Cl. G06F 19/00

(52) U.S. Cl. CPC G06F 19/3418; G06F 19/325; G06F 19/3437

(57) ABSTRACT

A smart device for monitoring and capturing patient data and systems, assays and methods of using the device, the smart device comprising a memory for storing a dynamic disease model and patient data, at least one input for receiving patient data and storing such patient data in the memory of the smart device, and a dynamic output driven by the dynamic disease model in response to capture of patient data.

The present invention provides a device and systems, assays and methods of using the device particularly, but not exclusively, of and/or for predicting disease trajectory in a patient based on ongoing measurement of disease and/or personal parameters in the patient and identifying a treatment plan, with applications in managing delivery of treatments and care to a patient or directly improving outcomes for patients.

### BACKGROUND

Disease models are made by obtaining patient data from a large number of patients suffering from a specific type of disease. Models can be built for almost any disease or condition and are particularly useful for chronic conditions, such as asthma, dementia, HIV/Aids or cancer, for example, where data is collected from patients at particular stages of disease development, progression, or, in some cases, remission. A disease model provides information on multiple disease trajectories and optionally how the disease has responded to treatment in multiple patients at different stages of the disease.

Physicians make use of disease models by comparing individual patients as they present, or as they respond to treatment, to the disease trajectories modelled by the disease model. Disease models are used by physicians for supporting diagnosis and monitoring disease progression. Such models are invaluable for enabling physicians to give patients clear information regarding their prognosis based on scientific fact.

Disease models are typically static, being based on historical data often collected many years earlier, and only updated very occasionally when the scientific consensus has evolved or new treatments have become well established. This means that disease models relied upon by medical practitioners can be based on outdated methods of diagnosis or treatment. Patient data which is typically used to create a disease model includes, but is not limited to, patient demographic data, physiological and neurophysiological testing, biomarkers (for example from blood or other patient-derived sample tests including biopsy), imaging (e.g. MRI, PET, CT, MEG) and genetic data.

Conventional methods of providing a patient prognosis rely on comparing a single set of patient data to a static disease model which may have been created some time beforehand. This has two important limitations: i) it is common for physicians to be working with outdated, generic disease models which may not reflect changes to treatment or understanding of the disease. ii) using a single set of patient data to provide a prognosis does not take into account the individual patients' long term response to treatment nor can the disease model be amended to suit the individual patient.

The present inventions seek to provide solutions that address the aforementioned problems.

### SUMMARY

An aspect of the invention provides a smart device (for example worn by the patient or placed in the patient's home) for monitoring and capturing patient data, the smart device comprising a memory for storing a dynamic disease model and patient data; at least one input for receiving patient data and storing such patient data in the (local or remote) memory of the smart device; and at least one dynamic output driven by the dynamic disease model in response to capture of patient data. The dynamic disease model may itself be adaptive and the dynamic output may be a change in treatment, a phone call or text message to a carer or the emergency services, an e-mail or other data message to a physician, for example.

A patient-specific model can be created from a static generic model and individual patient data, and in this invention, that patient-specific model is dynamic, enabling it to be updated with new measurements made from the patient, or new information about the patient and their treatments. The dynamic disease model stored on the smart device of the first aspect of the invention is personal to the patient and can thus be updated, in some circumstances, instantaneously when data is captured by the smart device.

Use of a smart device to capture data and update a dynamic disease model is advantageous as it allows for a copy of the dynamic disease model to be close to or carried by the patient and provides means for updating the dynamic disease model either instantaneously or on demand. This is not possible with a static generic disease model for both practical and regulatory reasons. A regularly updated dynamic disease model allows for a more detailed tracking of the patient's progression, and for refined prognosis and treatment plans to be provided to the patient, and (through suitable security) everyone involved in the patient's well-being thus providing higher quality treatment and care to the patient.

In a further aspect of the invention, an output of the dynamic disease model is an adaptive “treatment and care plan” that changes in response to actual treatment and care the patient has received, and their ability to look after themselves.

A further aspect of the invention, is that an output of the disease model can be a message about the patient's disease state sent once or periodically to external agencies such as emergency services. For example, if a patient with dementia calls for an ambulance, the ambulance service may already have ben notified that the patient has dementia symptoms and would therefore modify the response to ensure that the patient was not then taken inappropriately to an acute hospital for treatment, which would be of no benefit to and may actually be deleterious to the patient.

A further aspect of the invention provides a disease model comprising a generic disease model based on a data repository of patient measurements and/or information; a dynamic disease model derived from the generic disease model, the dynamic disease model being specific to an individual patient and containing patient measurements and/or information specific only to the individual patient; an input for receiving initial patient measurements and/or information and additional patient measurements and/or information; a first algorithm for comparing the initial patient measurements and/or information to the generic disease model; a second algorithm for comparing the additional patient measurements and/or information to the generic disease model and an output indicating a patient prognosis and/or treatment plan based on information contained in the generic disease model and in the dynamic disease model. Such an output may be in the form of a phone call or text message to the patient to tell them to alter their treatment regimen, to the carer or the emergency services, or may be an e-mail or other data message to a physician, for example.

As explained in relation to the first aspect of the invention, a generic disease model cannot be updated instantaneously due to practical, regulatory and privacy issues. Use of a dynamic disease model derived from a generic disease model enables physicians to tap into the vast quantity of data held in the generic disease model but refined with that data that is actually relevant to the patient. Accordingly, the dynamic disease model can provide an actual and specific model of the patient's disease based on historic data relating to anonymized patients whom had similar symptoms, treatment and progression of the disease, for example.

A further aspect of the invention provides a prognostic and diagnostic assay for predicting disease trajectory in a patient based on ongoing measurement of disease parameters in the patient and dynamically ly identifying and/or refining a treatment and care plan, the assay comprising: a generic disease model, fitted to an individual patient to create a dynamic patient-specific disease model that is capable of updating in response to input of patient measurements; a measurement device for taking a measurement and/or information from a patient; an input device for inputting the measurement and/or information into the dynamic disease model; an algorithm for comparing the measurement and/or information to the generic disease model, updating the dynamic disease model and calculating disease development and prognosis; and, an output providing at least the patient's prognosis and/or identifying a treatment and plan, wherein, input of measurements into the dynamic disease model activates the algorithm and the dynamic disease model is refined to take into account the patient's measurements and output a refined prognosis and treatment plan personalized to the patient.

Generic disease models can have limited performance because they lack specific information about a particular patient, or can be difficult to interrogate based on the large amount of data they store and they are often too general and not patient-specific. Use of an assay for predicting disease trajectory by fitting a generic disease model to an individual patient through a derived dynamic disease model enables a user such as a physician to use specific patient data to refine the dynamic disease model. Spurious patient data can be ignored and the physician can apply best practice that might not have been incorporated into the generic disease model.

A further aspect of the invention provides a method of dynamically providing a patient prognosis, the method comprising:
a) using an input device to obtain one or more measurements and/or information from a patient;
b) sending the one or more measurements and/or information to a remote processing device;
c) instantiating a dynamic patient-specific disease model from a generic disease model that contains historic patient data,
d) updating the dynamic disease model with the one or more measurements and/or information;
d) using the remote processing device to compare the one or more measurements and/or information to the generic disease model;
e) using the remote processing device to generate a patient prognosis and treatment plan based on the dynamic disease-model;
f) sending the prognosis and treatment plan from the remote processing device to an output device;
g) repeating steps a) to f) over a period of time to refine the dynamic—disease model and improve accuracy of the patient prognosis.

A further aspect of the invention provides a method of managing disease treatment, the method comprising:
a) providing an input device configured to communicate with a remote data processing device;
b) sending patient measurements and information relating to a disease to the remote data processing device;
c) receiving data relating to a patient treatment plan and prognosis from the remote data processing device; and
d) implementing a treatment and/or care plan according to the data received from the remote data processing device.

A further aspect of the invention provides a method of managing disease treatment and/or care, the method comprising:
a) providing a remote data processing device configured to communicate with an input device;
b) receiving patient measurements and information from the input device relating to a disease;
c) adding said patient measurements to a disease model;
d) comparing said patient measurements to the disease model;
e) calculating a patient prognosis and suggested treatment and/or care plan; and
f) sending said patient prognosis and suggested treatment and/or care plan to an output device.

An output device includes a local or remote computer, a handheld or mobile device, a printer or a patient record system for example.

A further aspect of the invention provides a tool for supporting development and evaluation of drug and/or non-drug treatments comprising: a smart device (eg: in the patient's home or worn by the patient) having one or more inputs for capturing patient data and/or information, communications means between the smart device and a remote processing device; an algorithm for comparing patient data and/or information captured by the one or more inputs with pre-determined parameters; and an output fly or dynamically updating a treatment plan in response to comparison of the patient's measurements and/or data with the pre-determined parameters.

During clinical trials of drug or non-drug treatments, patients can experience side effects which in certain circumstances can be a serious risk to health. Having an automated monitoring tool which captures patient data and/or information and relays this to a physician or remote device enables the safety of any experimental treatment to be precisely assessed, and also for potential risks to the patient to be identified at an early stage and medical treatment to be sought and/or the treatment plan to be adjusted to mitigate side effects.

A further aspect of the invention provides a patient monitoring system comprising a smart device for monitoring one or more patient characteristics, the smart device having an alert function for activating an alarm if a patient characteristic exceeds or falls below a threshold value as set in the smart device.

Automated monitoring of a patient is desirable if the patient is suffering from one of a number of diseases in order that the patient can be immediately advised what action he or she needs to take in response to a particular event or emergency services can be notified.

A further aspect of the invention provides a dynamic method of treatment of a disease and/or care of a patient with the disease, the method comprising:
a) capturing a first set of patient measurements and/or information;
b) sending the first set of patient measurements and/or information to a remote processing device;
c) using the remote processing device to compare the first set of patient measurements and/or information to a control data set;
d) identifying the stage at which the disease has developed to and appropriate treatment strategies;
e) sending the treatment strategies from the remote processing device to an output;
f) displaying the treatment strategies on an output device;
g) capturing a second set of patient measurements and/or information;
h)sending the second set of patient measurements and/or information to the remote processing device;
i) using the remote processing device to compare the second set of patient measurements and/or information to the first set of patient measurements and/or information and to the control data set; refining appropriate treatment and/or care strategies;
j) sending the refined treatment and/or care strategies to the output, and
k) repeating steps g) to j) as necessary.

### FIGURES

Certain embodiments of the invention will now be described by way of reference to the following figures:

FIG. 1 shows a diagrammatic example of a disease model according to embodiments of the present invention

FIG. 2 shows how the fit of patient data to a reference model learned from a large dataset can iteratively be refined.

FIGS. 3 and 4 show the dynamic nature of the disease model through the combination of structural imaging with an amyloid marker or genotype.

FIG. 5 shows how the hospital based system and home based system of the invention interact in the patient journey.

FIG. 6 shows how the device updates the dynamic personalized disease model, outputs from which include care and treatment plans and emergency plans that can be shared with emergency services.

### DESCRIPTION

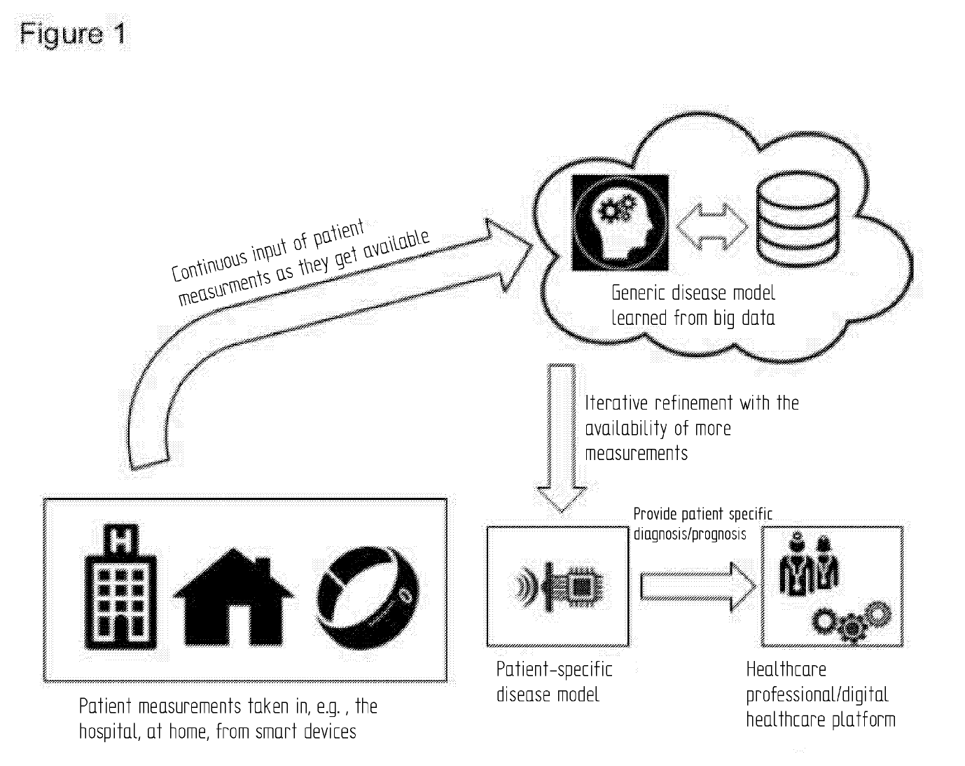

A generic disease model as shown in FIG. 1 and envisaged by the present invention is based on a large dataset of measurements and information taken from multiple patients over a significant time period. Such measurements and information are anonymized and uploaded periodically to a generic, data disease model. Generic disease models are required for each individual disease as each disease displays unique symptoms and requires different measurements and information to be taken from patients in order to monitor development of the disease.

The present invention has been postulated as suitable for chronic diseases including: the diseases causing dementia (eg: alzheimers), mental health disorders, HIV/AIDS, cancer, asthma, diabetes, for example, but is not limited in use to such diseases. The present invention is suitable for use in any disease which requires ongoing monitoring and which has displayed itself in a sufficient number of patients.

A dynamic disease model according to embodiments of the present invention is derived from a generic disease model and is unique to a particular patient. Initial patient data is used to select data in the generic disease model which closely corresponds to the patient. From this, an initial prognosis and/or treatment plan is generated based on the content of the dynamic disease model.

The dynamic disease model is updatable with additional patient measurements and/or information in order to refine the initial prognosis and/or treatment plan as the patient's disease progresses or more patient data gets available.

Taking a disease model for asthma as an example, such patient data and/or measurements might include: peak flow rates, preventative inhaler dosage, preventative inhaler treatment plan, preventative inhaler actual frequency of use, reliever inhaler dose, reliever inhaler frequency of use, patients perception of how their asthma is controlled, any attacks or episodes of shortness of breath, trigger factors, weight, age, height, demographic, for example.

Taking a disease model for dementia as a further example, such patient data and/or information might include: demographic information about the individual (gender, age, educational history . . . ), the output of cognitive tests, the output of a depression score, blood tests to assess vitamin deficiencies, the patient's genotype such as their APOE4 carrier status, vascular risk factors, measurements from brain scans, measurements from CSF assays, results from blood tests of dementia risk-factors.

Upon diagnosis of a disease or condition, a medical professional can generate the dynamic disease model. The dynamic disease model is stored on secure digital storage medium and can be updated either instantaneously when further patient measurements and/or information are available or on demand. Upon each update, the dynamic disease model uses an algorithm to refer to the generic disease model and generate an updated prognosis and/or suggested treatment plan. A medical professional can thus identify how patient's with similar symptoms and measurements were treated, how effective such treatment was and how other patient's disease or condition progressed in comparison to the actual patient being assessed. The disease model can also be used to extract useful information for patient treatment from these high-dimensional datasets.

Patient measurements and/or information can be obtained in any number of ways. In the simplest form of the present invention, patient measurements and/or information may be obtained using suitable techniques and written down on paper. The patient measurements and/or information can then be uploaded manually to the patient's dynamic disease model by an operator.

Alternatively, a tablet computer could be used by a medical professional or carer to enter patient data and/or information. A tablet computer can also be used by the patient to answer simple questions relating to his or her condition, their feelings or their activities, for example.

In a particular embodiment of the present invention, the dynamic disease model is stored on a smart device such as smart watch or pendant or device mounted to the wall(s) of the patient's home. The dynamic disease model can be uploaded onto the smart device by either wired communication such as USB or wireless communication such as WiFi or Bluetooth. Alternatively, the dynamic disease model can be stored on removable storage media compatible with the smart device.

The smart device allows for automated monitoring of certain patient measurements and/or information. For example, a smart device used for monitoring a patient suffering from dementia can monitor a patient's location to identify whether the patient could remember how to get to and from a particular place within the home or in the wider community. Such a feature for a smart device carried by the patient would also enable emergency services to locate the patient should the patient get into difficulty or get lost.

The smart device can also monitor the patient, such as vital signs including heart rate and respiration, facial expressions, movement and or gait, to identify if the patient is in distress. Upon determining that a patient is in distress the smart device can communicate with the patient or people involved in the looking after the patient to enquire whether the patient requires assistance. The patient or others contacted would then have the option to contact emergency services for assistance. Depending on parameters set by a medical professional and data sent by the smart device to emergency services, an ambulance can be sent if required or a first responder or nurse if the patient's condition is not serious. In this way, appropriate emergency intervention can be provided, but inappropriate hospitalization avoided.

Some embodiments of smart devices can have input means such as a touch screen or buttons that the patient, a medical professional or a carer can use to input patient measurements and/or information. Such an embodiment also enables a patient to answer simple questions about how he or she feels, or whether planned treatment and/or care has been delivered, and this information can be used to refine the dynamic disease model.

When the patient visits a medical professional, the smart device can communicate with a computer or tablet to display the dynamic disease model. The smart device can function in one of two ways: 1) it can update the dynamic disease model as and when new patient data and/or information is captured; or 2) it can store new patient data and/or information and update the dynamic disease model only when it is in communication with a specified computer or tablet.

In other embodiments, the smart device can store an adaptive or dynamic treatment plan in addition to or in place of the dynamic disease model. The treatment plan sets out the treatment prescribed for the patient and is updatable based on patient measurements and/or information which can be captured by the wearable device, or otherwise.

The treatment and/or care plan can be updated remotely in response to patient data and/or information which is captured by the wearable device. In a particular embodiment of the invention, patient data and/or information is captured by the smart device and then communicated instantaneously by the Global System for Mobile Communications (GSM) to a remote processing device. The remote processing device receives the patient data and/or information and relays the patient data and/or information to a server containing a global disease model.

The global disease model recognizes the patient data and/or information and activates an algorithm to compare the patient data and/or information to data and/or information stored in the generic disease model. Based on the comparison step, an output is sent to the dynamic disease model stored on the wearable device by GSM to update the dynamic or adapative disease model to take into consideration the patient data and/or information captured by the wearable device.

The dynamic disease model produces an output to update the treatment plan with updated treatment for the patient.

The treatment plan can be set with an alarm in the case of the patient exhibiting behavior or symptoms which indicate that the patient's health is at risk. As an example, a Global Positioning Satellite (GPS) enabled smart device that is carried by the patient (wearable) can monitor a patient's location. In the event that GPS indicates the patient is lost, i.e. by detecting that the patient has been walking around in a circle for a certain amount of time, the treatment plan can request input from the patient via the wearable device to indicate whether the patient needs assistance. In the event of an affirmative or no response, the wearable device can send a signal to a monitoring centre indicating that the patient should be contacted and if the patient is uncontactable, emergency services can be notified.

A smart device that is not wearable may monitor the patients' position within their home or care-home to record their amount and type of activity, eg: whether a dementia patient is getting out of bed, moving to other parts of the house etc and this can help assess whether that patient is functioning independently.

The treatment and/or care plan can also be used as a tool for supporting development and evaluation of new drug and non-drug treatments. In such a scenario, the smart device would capture patient data and/or information and send this to a remote processing device by GSM or wifi or similar means. The remote processing device would relay the data and/or information to either a person involved in the care of that patient, or a big data repository of clinical trial data. The patient data and/or information can be reviewed manually by the person involved in that person's treatment and care or autonomously by an algorithm in order to monitor the effect of the drug or non-drug treatment on the patient. Based on how the patient is responding to the drug or non-drug treatment, the treatment plan can be updated to vary the treatment, terminate the treatment or maintain the treatment. In the event that the wearable device captures data and/or information that indicates the patient is suffering from unforeseen or undesirable side effects from the drug of non-drug treatment, that information can be captured as part of assessing the safety of that experimental treatment, but also the treatment plan can be updated with an alarm code indicating to the patient that they require medical attention. Alternatively, the treatment plan can be pre-conditioned with an alarm which would indicate to the patient that they require medical attention if certain parameters become evident in the patient.

### EXAMPLES

This example demonstrates an application of the invention in patients with cognitive difficulties including MCI and dementia.

### Prognosis of Cognitive and Functional Decline at Diagnosis.

Identification of patients with cognitive impairment (eg: MCI, dementia) at the highest risk of future cognitive or functional decline is important clinically. Much work has been done on the predictive power of clinical tests alone. Those older adults that show less cognitive decline as they age are less likely to report comorbid medical conditions and decreases in activities of daily living than people who exhibit more decline. Intervening earlier in the disease process can make treatments more effective and allow better management of that patient's care. It has also been suggested that people who decline cognitively and functionally, more quickly than others have a poorer prognosis and require more resources to manage their care. Brain biomarkers are significant contributors in the diagnosis of dementia. In recent years research has shown that predictive models of dementia risk are more accurate when they include multiple risk factors.

There are already several well characterized biomarkers for dementia (CSF, PET, structural MRI imaging that can be used to support diagnosis, all of which have been qualified as biomarkers to enrich clinical trials by EMA). Recent literature shows the advantage of combining them and integrating them with existing diagnostic tests like neuropsychological testing. Research has highlighted the benefit of combining MRI measurements with cognitive testing when trying to predict dementia risk. Specifically studies have shown that combining cognitive tests and regional brain volume measures were the best at predicting conversion to dementia in patients with mild cognitive impairment.

### Dementia Prognosis Index

An embodiment of this invention, provides a prognosis index that predicts cognitive and functional decline from structural imaging and baseline clinical assessment. This index works by generating a patient specific disease model that predicts cognitive and functional decline, by comparing multiple measurements obtained from the patients with a generic disease model incorporating a large database of normal and demented patients who have been followed up for at least 24 months. The prognostic index is an output of this personalized model, and a practical output of this model is patients being classified as Rapid Cognitive Decliners (RCD) or Rapid Functional Decliners (RFD) if the rate of decline is predicted to be >=8 MMSE points or >=10 FAQ points over 2 years respectively. The prognosis index is based on the medial temporal lobe atrophy index, MTAI (combination of structural volumes for the hippocampus, amygdala, temporal horn and lateral ventricles) as extracted with a hospital based device from the baseline MR image as well as the relevant demographics, baseline clinical score, MMSE or FAQ. Both features are used for Gaussian mixture population estimation. The difference between rapidly progressing and non-progressing (cognitively or functionally) populations was modelled as a sigmoid function in order to obtain a likelihood to belong to the progressing or stable subject groups. Class-likelihood indices derived from both MTAI-MMSE and MTAI-FAQ were used to predict RCD and RFD subjects on a test dataset. Prediction accuracies of 74% and 80% were respectively obtained when using both sources of information. This compares to 68% (MTAI only) and 68% (MMSE only) for cognitive decline. Accuracies of 70% (MTAI only) and 73% (FAQ only) where achieved with individual measurements to predict functional decline. These results show how the defined disease model of structural imaging and baseline clinical assessment (MMSE/FAQ) gives an improved prognosis as to whether a subject is likely to rapidly deteriorate in cognition (RCD) or function (RFD) compared to an individual assessment of the clinical score or structural imaging.

The patient specific model is dynamic, in that it can be updated with additional measurements collected later, including repeat brain scans, or additional patient measurements, including biomarkers of amyloid, or genotype information (such as APOE4 carrier status).

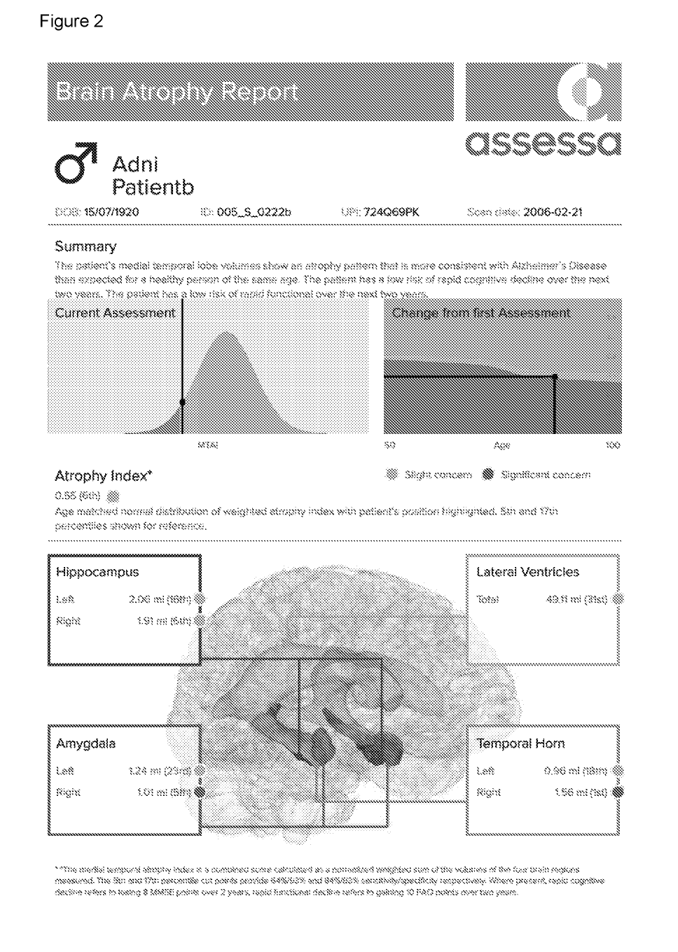

An example for the refinement of a disease model is the addition of longitudinal structural information to the MTAI index referred to above. With the availability of only baseline structural information, a relatively simple, patient-specific instance of the global disease model is used (ie the baseline MTAI (combining multiple structural volumes at baseline)). This relatively basic model provides an accuracy of 83% for the discrimination between healthy and dementia subjects, only improving from 79% and 78% when using hippocampal or amygdala volume alone respectively without disease modelling. With the availability of longitudinal structural information, a refined instance of the model is available for a specific patient. On the used test dataset, this additional information can improve classification accuracy to 89%. Combining structural information with non-imaging data as exemplarily shown above can further improve prognostic/diagnostic accuracy, showing how an the fit of patient data to a reference model learned from a large dataset can iteratively be refined. See FIG. 2.

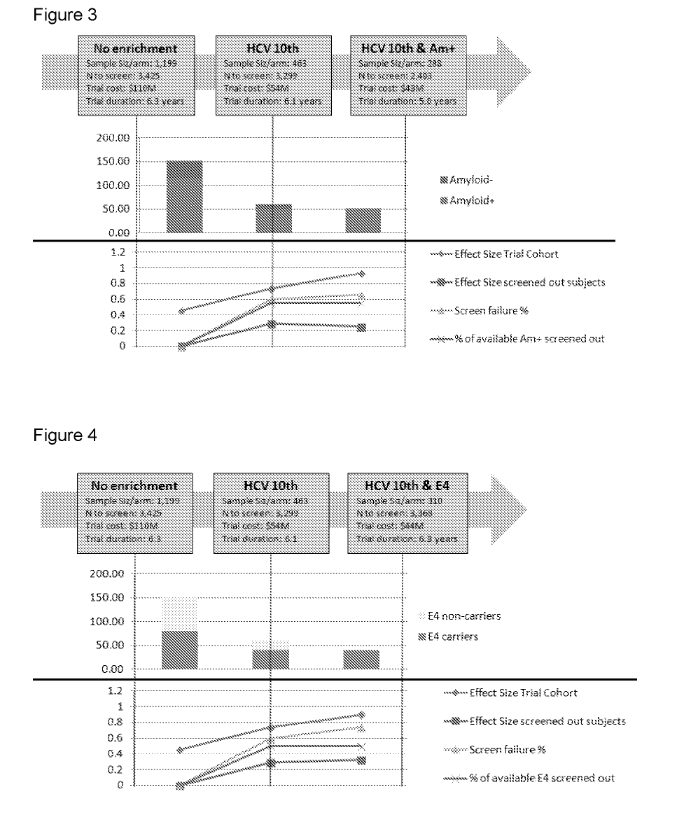

A second example of the dynamic nature of the disease model is illustrated in the FIGS. 3 and 4 through the combination of structural imaging with an amyloid marker or genotype: in this example it is shown that the rate of cognitive decline is higher with multiple positive markers (structural imaging & amyloid and structural imaging & genotype). In this particular application of the invention, the prognostic information can be used to enrich clinical trials of new treatments.

A further example for the dynamic nature of the disease model is in the integration of post-diagnosis information: Post-diagnosis information is collected both from subsequent hospital visits (eg: repeat brain scans or cognitive assessments) and from other data and information entered by the patient and those that are involved in their well-being, both in their family and outside. The availability of such information can update the patient-specific instance of the disease model. The device or devices for collecting this post-diagnostic information is located in the patient's home. It includes a profile of the patient populated by the patient and their family to assist those caring for them to provide more personalized care and also to make the device “sticky” so the patient and their immediate family want to continue to engage with it: content like music, pictures, poems that the patient enjoys, information about their preferences as they may change. The home-based system according to the invention uses the information about the patient (demographics, information from diagnosis and subsequent assessment) to update the patient-specific dynamic model (which may have been an output of hospital-based system according to the invention or may have been provided by an entering data separately) and record the patients own goals and priorities. The output of the system includes a dynamic care plan, and also the ability to input data manually or automatically from smart devices that both monitor whether the patient has been meeting their personal objectives, and whether the patient's dynamic disease model of cognitive and functional decline is predicting change in what they can achieve accurately, and if not, to update this.

For example, if the patient has goals to go out to the day centre and walk around the park twice per week, whether this is achieved can be tracked.

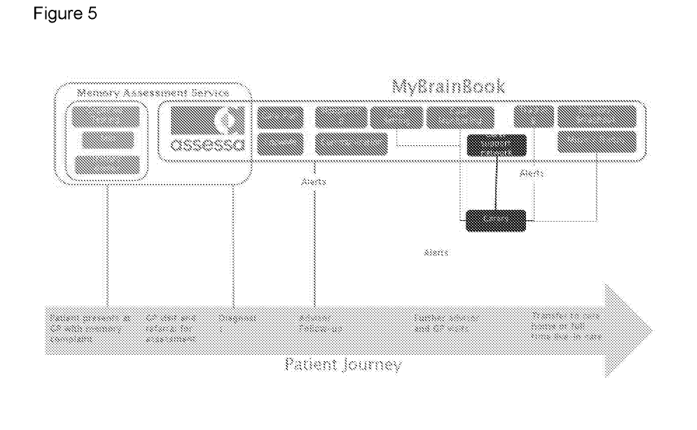

A feature of the hone-based system is that it can message the emergency services with information about the patient that can inform how any calls to these services are dealt with, and avoid inappropriate responses. The schematic in FIG. 5 shows how the hospital based system and home based system of the invention, interact in the patient journey.

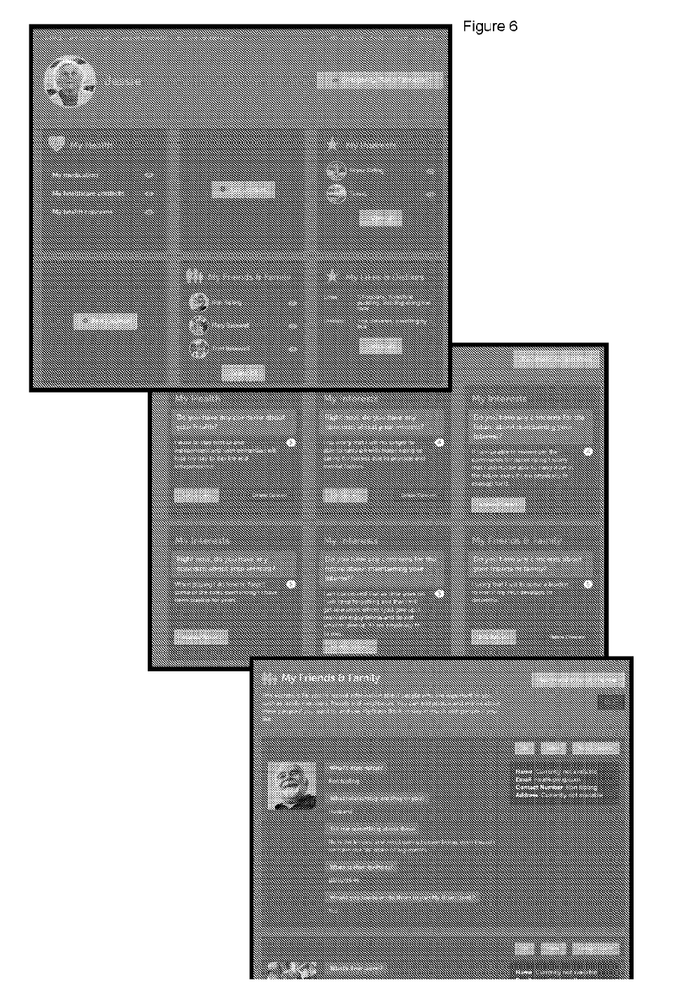

Information, and care action plan. This patient-facing-interface can collect further information and data about the patient to update the dynamic personalized disease model, outputs from which include care and treatment plans and emergency plans that can be shared with emergency services. See FIG. 6.

1. (canceled)

2. A disease model comprising:
a generic disease model based on a data repository of patient measurements and/or information;
a dynamic disease model derived from the generic disease model, the dynamic disease model being specific to an individual patient and containing patient measurements and/or information specific only to the individual patient;
an input for receiving initial patient measurements and/or information and additional patient measurements and/or information;
a first algorithm for comparing the initial patient measurements and/or information to the generic disease model;
a second algorithm for comparing the additional patient measurements and/or information to the generic disease model; and
data extracted from the generic disease model and instantiated in the dynamic disease model.

3. (canceled)

4. A method of dynamically providing a patient prognosis, the method comprising;
a) using an input device to obtain one or more measurements and/or information from a patient;
b) sending the one or more measurements and/or information to a processing device;
c) instantiating a dynamic patient-specific disease model from a generic disease model that contains historic patient data;
d) using the remote processing device to compare the one or more measurements and/or information to the generic disease model;
e) using the remote processing device to generate a patient prognosis and treatment/care plan based on the dynamic disease-model;
f) sending the prognosis and treatment/care plan from the remote processing device to an output device; and
g) repeating steps a) to f) over a period of time to refine the dynamic-disease model and improve accuracy of the patient prognosis and/or appropriateness of the treatment/care plan.

5-8. (canceled)

9. A dynamic method of treatment of a disease, the method comprising:
a) capturing a first set of patient measurements and/or information;
b) sending the first set of patient measurements and/or information to a remote processing device;
c) using the remote processing device to compare the first set of patient measurements and/or information to a control data set;
d) identifying the stage at which the disease has developed to and appropriate treatment and/or care strategies;
e) sending the treatment/care strategies from the remote processing device to an output;
f) displaying the treatment strategies on an output device;
g) capturing a second set of patient measurements and/or information;
h) sending the second set of patient measurements and/or information to the remote processing device;
i) using the remote processing device to compare the second set of patient measurements and/or information to the first set of patient measurements and/or information and to the control data set; refining appropriate treatment strategies;
j) sending the refined treatment strategies to the output; and
k) repeating steps g) to j) as necessary.
